(19) United States
(12) Patent Application Publication
(10) Pub. No.: US 2022/0027722 A1
(43) Pub. Date: Jan. 27, 2022

(54) Deep Relational Factorization Machine Techniques for Content Usage Prediction via Multiple Interaction Types

(71) Applicant: Adobe Inc., San Jose, CA (US)

(72) Inventors: Gang Wu, San Jose, CA (US); Viswanathan Swaminathan, Saratoga, CA (US); Ryan Rossi, Santa Clara, CA (US); Hongchang Gao, Kingston, PA (US)

(21) Appl. No.: 16/939,661

(22) Filed: Jul. 27, 2020

(51) Int. Cl. G06N 3/08; G06N 3/04

(52) U.S. Cl. CPC G06N 3/08; G06N 3/04

(57) ABSTRACT

A deep relational factorization machine (“DRFM”) system is configured to provide a high-order prediction based on high-order feature interaction data for a dataset of sample nodes. The DRFM system can be configured with improved factorization machine (“FM”) techniques for determining high-order feature interaction data describing interactions among three or more features. The DRFM system can be configured with improved graph convolutional neural network (“GCN”) techniques for determining sample interaction data describing sample interactions among sample nodes, including sample interaction data that is based on the high-order feature interaction data. The DRFM system generates a high-order prediction based on the high-order feature interaction embedding vector and the sample interaction embedding vector. The high-order prediction can be provided to a prediction computing system configured to perform operations based on the high-order prediction.

### TECHNICAL FIELD

This disclosure relates generally to the field of machine learning, and more specifically relates to selecting relevant content from a data source by applying deep relational factorization machine techniques to model high-order interactions among sample nodes or features.

### BACKGROUND

Automated prediction techniques are used for retrieving, from online data sources, digital content that is relevant to a user and providing that digital content to one or more personal computing devices of the user. Automated prediction techniques are often used to provide digital content that is relevant to or supportive of online activities for a computing device. For example, a user who requires information could use a computing device to browse a website for the required information. A contemporary automated prediction technique, in this example, recommends data based on the online activities of the user's computing device. For example, the example contemporary automated prediction technique can utilize pairwise interaction data by determining an interaction between two features of the online activities.

However, some automated prediction techniques are unable to utilize high-order feature interaction data that is based on interactions among three or more features. Such automated prediction techniques are limited to using only pairwise interaction data, and could recommend data that is less relevant compared to a prediction based on high-order feature interaction data. In addition, generation of pairwise interaction data for very large datasets, such as billions of data items, can be computationally intensive. For example, generating pairwise interaction data for a very large dataset can require computing operations for analyzing each data item pairwise against each other data item in the very large dataset. A contemporary automated prediction technique that is limited to utilizing pairwise interaction data could spend a relatively high amount of computational resources while recommending less relevant data.

### SUMMARY

According to certain embodiments, a deep relational factorization machine (“DRFM”) system accesses digital activity data, which includes one or more sample nodes. A sample node includes a feature vector representing binary features. A relational feature interaction component (“RFI component”) of the DRFM system generates a feature graph based on the binary features. The RFI component determines a high-order feature interaction embedding vector describing high-order feature interactions among at least three of the binary features. An sample interaction component (“SI component”) of the DRFM system generates a sample interaction embedding vector describing sample interactions between the sample node and an additional sample node from the digital activity data. The sample interaction embedding vector is based on a combination of the high-order feature interactions of the sample node and additional high-order feature interactions of the additional sample node. The DRFM system generates a prediction based on the high-order feature interaction embedding vector and the sample interaction embedding vector. The prediction indicates, for example, a probability of an additional digital activity based on the high-order feature interactions and the sample interactions. The DRFM system provides the prediction to a prediction computing system.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram depicting an example of a computing environment in which a deep relational factorization machine (“DRFM”) system generates a high-order prediction based on high-order interaction data, according to certain embodiments;

FIG. 2 is a diagram depicting an example of a DRFM that is capable of generating high-order interaction data, according to certain embodiments;

FIG. 3 is a flow chart depicting an example of a process for generating one or more of high-order interaction data or a high-order prediction, according to certain embodiments;

FIG. 4 is a diagram depicting an example of a DRFM system that generates one or more data structures representing a sample node, a feature vector, or a feature graph, according to certain embodiments;

FIG. 5 is a diagram depicting an example of an RFI component that includes a high-order feature interaction neural network and an RFI graph convolutional neural network, according to certain embodiments;

FIG. 6 is a diagram depicting an example of an SI component that includes a graph convolutional neural network, according to certain embodiments; and

FIG. 7 is a diagram depicting an example of a computing system for implementing a DRFM system, according to certain embodiments.

### DETAILED DESCRIPTION

As discussed above, prior techniques for generating automated predictions based on digital activities of a computing device are limited to using pairwise feature interaction data. In some cases, predictions that are limited to pairwise feature interaction data are less accurate and require more computational resources, as compared to a high-order prediction that is based on high-order feature interaction data. Certain embodiments described herein involve a deep relational factorization machine (“DRFM”) system that generates a high-order prediction. An example of a high-order prediction is a prediction determined based on high-order feature interactions, such as interactions among large groups of features in a dataset of digital activities. In some cases, the high-order feature interactions include interactions among large groups of features from the dataset, such as interactions among several hundred (or more) features. These embodiments facilitate more effective identification and retrieval of relevant digital content because, for instance, by identifying interactions among large groups of features more quickly and efficiently (e.g., compared to a prior prediction technique using pairwise interactions).

The following examples are provided to introduce certain embodiments of the present disclosure. In this example, a DRFM system receives an online activity dataset that includes multiple sample nodes including multiple feature vectors. Each sample node represents online activities associated with a particular computing device, and one or more feature vectors in that sample node represent characteristics of these online activities for the particular computing device. The DRFM system includes a relational feature interaction component (“RFI component”) and a sample interaction component (“SI component”). The RFI component is configured using improved techniques for a factorization machine (“FM”), such as improved FM techniques that include generating a feature graph and determining high-order feature interactions based on paths among features in the graph. Additionally or alternatively, the SI component is configured using improved techniques for a graph convolutional neural network (“GCN”), such as improved GCN techniques for determining interactions among sample nodes based on the high-order feature interactions determined by the RFI component.

The DRFM system generates a high-order prediction from the online activity dataset. To do so, the RFI component generates high-order feature interaction (“FI”) data describing interactions among three or more features of the sample nodes. For instance, the RFI component generates a feature graph based on features of a sample node. By identifying paths among three or more features in the graph, the RFI component generates the high-order FI data using the features associated together in the graph (e.g., joined by one or more paths). Furthermore, the SI component generates, from the high-order FI data, sample interaction (“SI”) data describing interactions among the sample nodes. For instance, the SI component determines interactions among a sample node and neighboring nodes based on the high-order FI data for the sample node and the neighboring nodes. The DRFM system generates a high-order prediction based on a combination of the high-order FI data and the SI data, such as a prediction that includes a concatenation of embedding vectors representing the high-order FI data and the SI data. In some cases, the DRFM system provides the high-order prediction to an additional computing system, such as a prediction computing system. The additional computing system performs one or more operations based on the high-order prediction, such as determining digital content, identifying a security irregularity, communicating with one or more particular computing devices associated with the sample nodes, or other suitable operations in a computing environment.

Certain embodiments described herein improve existing computer-implemented techniques for retrieving digital content based on a high-order prediction that is determined by a DRFM system. The example DRFM system generates high-order feature interaction data that describes interactions among three or more features from a large, high-cardinality dataset. Generation of the high-order feature interaction data by the DRFM system is more computationally efficient than generating pairwise feature interaction data based on the large, high-cardinality dataset. For example, the DRFM system utilizes improved FM techniques that use a reduced set of computing operations to determine interactions within larger feature groups (e.g., three or more features) within the dataset. In addition, the high-order prediction determined by the DRFM system more accurately indicates digital content for retrieval, compared to contemporary prediction techniques that do not utilize high-order feature interaction data. The contemporary prediction techniques are unable to determine feature interactions among larger features groups (e.g., three or more features), and could fail to adjust a prediction to account for the high-order feature interaction data.

In some cases, a DRFM system can receive a dataset describing digital activities of multiple computing devices, such as a dataset in which the digital activities are organized as sample nodes that are associated with respective computing devices. The example DRFM system is configured to use improved FM techniques for determining high-order FI data among three or more features, including groups of three or more features that are included in multiple sample nodes. The improved FM techniques may offer more accurate high-order FI data, as compared to contemporary FM techniques that are capable of determining pairwise FI data between two features (e.g., pairwise FI data without high-order FI data). Additionally or alternatively, the DRFM system is configured to use improved GCN techniques for determining SI data based on high-order FI data, such as high-order FI data that is generated based on the improved FM techniques.

In some cases, the DRFM system configured to use the improved FM and GCN techniques is able to provide a high-order prediction that is more accurate as compared to an automated prediction based on contemporary FM or GCN techniques. The high-order prediction may have a higher relevance to a user of a computing device, such as by including information that is more accurate or of higher interest, as compared to the automated prediction based on the contemporary techniques. For instance, an automated prediction based on a contemporary FM technique may be unable to determine high-order FI data. Additionally or alternatively, the contemporary FM techniques may assume that a sample node (e.g., a record of digital activities for a particular computing device) is independent of other sample nodes, and may be unable to utilize relational interactions between or among nodes. Furthermore, an automated prediction based on a contemporary GCN technique may be unable to utilize sparse data, such as sample nodes that are missing values for a large number of features.

As used herein, the term “neural network” refers to one or more computer-implemented networks capable of being trained to achieve a goal. Unless otherwise indicated, references herein to a neural network include one neural network or multiple interrelated neural networks that are trained together.

As used herein, the terms “node” and “sample node” refer to data records that are configured to store digital information. Information stored in a sample node can be represented by one or more features that are included in the sample node. In some cases, a sample node includes information about digital activities performed by a computing device.

As used herein, the term “feature” refers to data that represents a portion of information stored in a sample node. A feature can represent a particular characteristic about digital activities represented by a sample node. As a non-limiting example, if a sample node represents a digital activity that includes playing a video, the example sample node can include one or more features that represent characteristics of playing the video, such as a feature indicating whether or not the video was played to completion, a feature indicating whether the video was muted during play, a feature indicating whether the video was longer than 30 seconds in duration, or other suitable characteristics of the video-playing activity.

In some cases, a feature is a binary feature. A binary feature can have a Boolean value, such as “True” or “False,” 1 or 0, or other Boolean value sets. In some cases, a binary feature can have an undefined value. For instance, if a binary feature can have a defined value of 1 or 0, an undefined value of the example binary feature may include the value “NULL,” “undefined,” “NaN” (e.g., “Not a Number”), or any other suitable datatype indicating that the example of binary feature has an unknown value. Continuing with the above example of the sample node representing playing a video, the example sample node could have a feature with a value of 1 if the video was played to completion, a value of 0 if the video was stopped before completion, or an undefined value if the video has not been accessed.

As used herein, the terms “vector” and “feature vector” refer to a quantitative representation of information included in a sample node. In some embodiments, a feature vector could have a particular row (or column) associated with a particular digital activity, the particular row (or column) having a very large quantity of columns (or rows) representing a very large number of features for the particular digital activity. In some cases, a feature vector for a particular digital activity can include millions or billions of features for the particular digital activity.

As used herein, the term “sparse data” refers to a group of multiple data records in which a very large percentage (e.g., about 90% or greater) of values for the data items are 0 or unknown. For example, an unknown feature can include a feature that is missing a value, has an undefined value (e.g., a value “NULL”), or otherwise has a value that is unknown. In some cases, a sample node can include sparse data, such as a sample node that includes a feature vector in which a very large percentage of features have unknown values.

As used herein, the term “large data” refers to a group of multiple data records in which a very large quantity of data records (e.g., millions of data records, billions of data records). As used herein, “large data” refers to data that is considered uncountable by a human user, such as a dataset or feature vector that includes a quantity of data items (e.g., sample nodes, binary features) that could not be counted, or otherwise operated on, by a person using pen and paper. In some cases, a sample node can include large data, such as a sample node that includes a very large quantity of features. Additionally or alternatively, a vector can include large data, such as a vector that includes a very large quantity of vector values. Furthermore, a dataset can include large data, such as a dataset that includes a very large quantity of sample nodes.

As used herein, the term “high-cardinality data” refers to a group of multiple data records in which a very large quantity of the included data records have unique values, such as unique values that are not duplicated by any other value in the group of data records. For instance, high-cardinality data could include thousands of unique values. Non-limiting examples of high-cardinality data can include postal codes, usernames, IP addresses, or any other collections of data that can include thousands (or more) of unique values. In some cases, high-cardinality data can have a very large dimensionality, such as millions or billions of dimensions (e.g., rows, columns) that correspond to features of the high-cardinality data.

As used herein, the terms “high-order interaction” and “high-order feature interaction” refer to an interaction that is determined among three or more features, such as three or more features from a feature vector. In some cases, a high-order interaction is determined among three or more features that are included in multiple feature vectors. In some cases, a high-order prediction is a prediction that is based on one or more high-order interactions. In some embodiments, a data structure representing high-order interactions can also represent pairwise interactions (e.g., between two features), in addition to representing high-order interactions among three or more features.

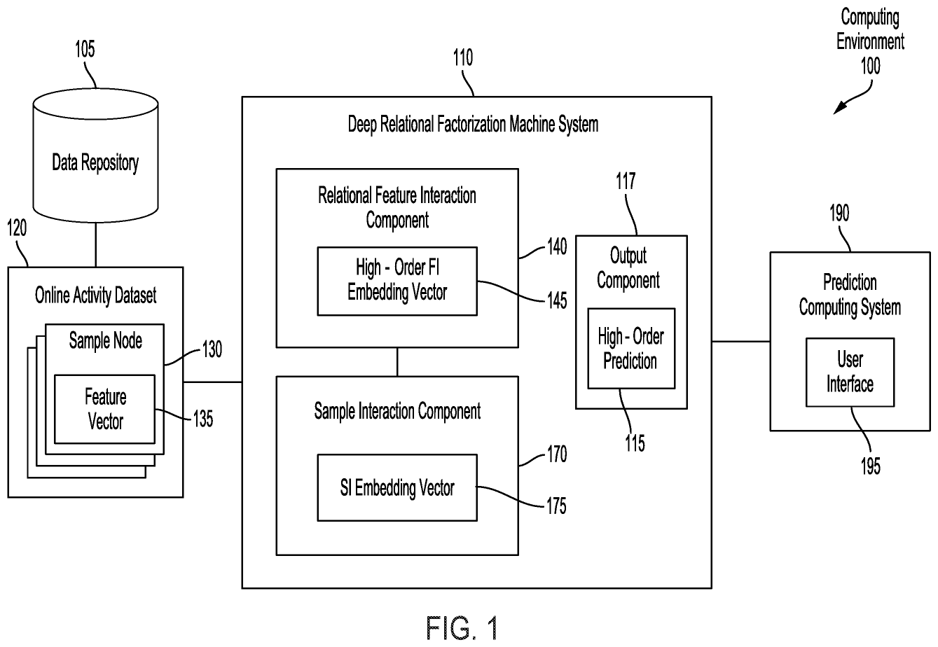

Referring now to the drawings, FIG. 1 is a block diagram depicting an example of a computing environment 100, in which a DRFM system 110 may generate a prediction based on determined high-order interaction data. The computing environment 100 can include one or more of the DRFM system 110, a data repository 105, or a prediction computing system 190. In some implementations, the DRFM system 110 may receive an online activity dataset 120. Based on the online activity dataset 120, the DRFM system 100 may determine high-order interaction data. Additionally or alternatively, the DRFM system 110 may generate a prediction, such as a high-order prediction 115, based on the high-order interaction data. In some cases, the DRFM system 110 may provide the high-order prediction 115 to one or more additional computing systems, such as the prediction computing system 190. For example, an output component of the DRFM system 110 could perform techniques for generating the high-order prediction 115, providing the high-order prediction 115 to one or more additional computing systems, or additional suitable techniques.

In FIG. 1, the data repository 105 can include one or more computing devices that are configured for storing large quantities of data, such as a database. The data repository 105 can store (or otherwise provide access to) data that describes digital activities of one or more computing devices. For example, the data repository 105 can include online activity data, such as the online activity dataset 120, describing activities that are communicated among multiple computing devices in a networked computing environment. The online activity data can describe activities communicated between two or more computing devices, including (without limitation) clicking on a link, loading an image or video, reading a social media post, creating an online account, establishing a relationship with an additional online account (e.g., “following” an online account of a particular user), completing a purchase, or any other digital activity that includes communicating data among multiple computing devices. In some implementations, the DRFM system 110 accesses digital activity data that is provided via the data repository 105. For example, the DRFM system 110 receives the online activity dataset 120 from the data repository 105. Although FIG. 1 depicts the data repository 105 as providing the online activity dataset 120, other configurations are possible. For example, the DRFM system 110 could receive multiple online activity datasets from multiple data repositories, or other sources of stored data.

In some implementations, the online activity dataset 120 includes one or more data records representing sample nodes, such as the sample node 130. Additionally or alternatively, each of the sample nodes in the dataset 120 can include a respective feature vector, such as a respective feature vector 135 included in the sample node 130. Each feature vector can include one or more binary features representing digital activities that could be performed by a respective computing device that is associated with the respective sample node. For example, the feature vector 135 includes multiple binary features for the sample node 130. Each of the binary features in the feature vector 135 represents a digital activity that can be performed by a particular computing device associated with the sample node 130. As a non-limiting example, a particular feature in the feature vector 135 can have a value of 1 or 0, indicating that the associated computing device has performed (e.g., value of 1) or has not performed (e.g., value of 0) an online activity associated with the particular feature. In some cases, the particular feature in the feature vector 135 can have an undefined value, indicating that it is unknown whether or not the associated computing device has performed the online activity. For instance, if the feature vector 135 has an example feature associated with playing a video, the example feature could have a value of 1 if the associated computing device has played the video to completion, a value of 0 if the associated computing device has stopped playing the video before completion, or an undefined value if the video has not been accessed by the associated computing device.

In some cases, one or more of the online activity dataset 120 or the data repository 105 can include data that is one or more of large data, high-cardinality data, or sparse data. For example, the online activity dataset 120 is a large dataset, such as billions of data records having billions of features, the data records being associated with billions of computing devices. Additionally or alternatively, the online activity dataset 120 is a high-cardinality dataset, such as unique data records associated with unique computing devices. Additionally or alternatively, the online activity dataset 120 is a sparse dataset, such as data records in which 95% or more of the features included in the data records are unknown or have a value of 0. As a non-limiting example, the online activity dataset 120 can include billions of unique sample nodes associated with billions of unique computing devices, each node having a respective feature vector with billions of features, in which 95% or more of the features in the respective feature vectors have undefined values.

In some implementations, the DRFM system 110 generates high-order interaction data based on the online activity dataset 120. In some cases, the high-order interaction data indicates relationships among multiple features included in a particular feature vector of a particular sample node. Additionally or alternatively, the high-order interaction data indicates relationships among multiple features included in multiple feature vectors of multiple sample nodes. As a non-limiting example, the DRFM system 110 could determine a high-order interaction among at least three features of the feature vector 135, such as a high-order interaction among features describing access of the video, playing the video to completion, and playing the video unmuted. In this non-limiting example, the DRFM system 110 could determine an additional high-order interaction among multiple features in the feature vector 135 and at least one additional feature vector, such as an additional high-order interaction among features describing playing the video to completion by a first computing device, linking to the video in a social media post via the first computing device, and playing the video to completion by a second computing device having a follower relationship (e.g., via the social media post) with the first computing device.

In FIG. 1, the DRFM system 110 includes an RFI component 140. Additionally or alternatively, the DRFM system 110 includes an SI component 170. In some cases, high-order interaction generated by the DRFM system 110 is based on data determined by one or more of the RFI component 140 or the SI component 170. For example, the RFI component 140 generates a high-order feature interaction embedding vector 145. The high-order FI embedding vector 145 describes high-order feature interactions (e.g., interactions among three or more features) of features included in the sample nodes of the online activity dataset 120. For example, the high-order FI embedding vector 145 can include data representing a high-order feature interaction among at least three binary features that are included in feature vector 135. In some embodiments, the high-order FI embedding vector 145 can represent pairwise feature interactions between two binary features, in addition to high-order feature interactions. In some cases, the RFI component 140 generates a high-order FI embedding vector for multiple respective nodes. For example, the component 140 generates the high-order FI embedding vector 145 associated with the sample node 130, and an additional high-order FI embedding vector for each additional sample node in the online activity dataset 120.

Additionally or alternatively, the SI component 170 generates a sample interaction embedding vector 175. The SI embedding vector 175 can describe sample interactions of sample nodes included in the online activity dataset 120. For example, the SI embedding vector 175 includes data representing a sample interaction between the sample node 130 and at least one additional sample node included in the dataset 120. In some cases, the SI embedding vector 175 is a high-order SI embedding vector describing high-order SIs among at least three sample nodes included in the dataset 120. In some cases, the SI component 170 generates an SI embedding vector for multiple respective nodes. For example, the component 170 may generate the SI embedding vector 175 associated with the sample node 130 (e.g., indicating interactions of the node 130 with additional nodes), and an additional SI embedding vector for each additional sample node in the online activity dataset 120.

In some implementations, the DRFM system 110 generates the high-order prediction 115 based on the determined high-order interaction data. In some cases, the high-order prediction 115 is determined based on a combination of one or more high-order FI embedding vectors or SI embedding vectors. Additionally or alternatively, the high-order prediction 115 could include, for multiple sample nodes included in the online activity dataset 120, a respective high-order prediction for each particular sample node. For example, the DRFM system 110 can generate a high-order prediction for the sample node 130 based on a combination of the embedding vectors 145 and 175. Additionally or alternatively, the high-order prediction 115 can include the high-order prediction for the sample node 130.

In FIG. 1, the DRFM system 110 provides the high-order prediction 115 to one or more additional computing systems, such as to the prediction computing system 190. Additionally or alternatively, the one or more additional computing systems are configured to perform one or more additional digital activities based on the high-order prediction 115. For example, the prediction computing system 190 is configured to provide information to group of one or more computing devices based on information included in the high-order prediction 115. In some cases, the one or more computing devices are associated with one or more of the sample nodes included in the online activity dataset 120. For example, the one or more computing devices may receive from the prediction computing system 190 information that is more accurate or has higher relevance, as compared to information provided by an additional computing system that does not receive the high-order prediction 115.

In some cases, the prediction computing system 190 includes, or is otherwise capable of communicating with, a user interface 195. The user interface 195 can include one or more input devices or output devices, such as a monitor, touchscreen, mouse, keyboard, microphone, or any other suitable input or output device. In some implementations, the high-order prediction 115 is generated based on inputs received via the user interface 195. For example, the DRFM system 110 could request the online activity dataset 120 from the data repository 105 based on one or more inputs indicating the dataset 120. Additionally or alternatively, the high-order prediction 115 can be provided to a user of the prediction computing system 190 via the user interface 195. For example, the user (e.g., a webpage developer, a content manager) could apply information that is included in the high-order prediction 115 to improve computer-based technologies, such as implementing improvements to a website, revising digital content items provided in an information service, or other suitable computer-based technologies.

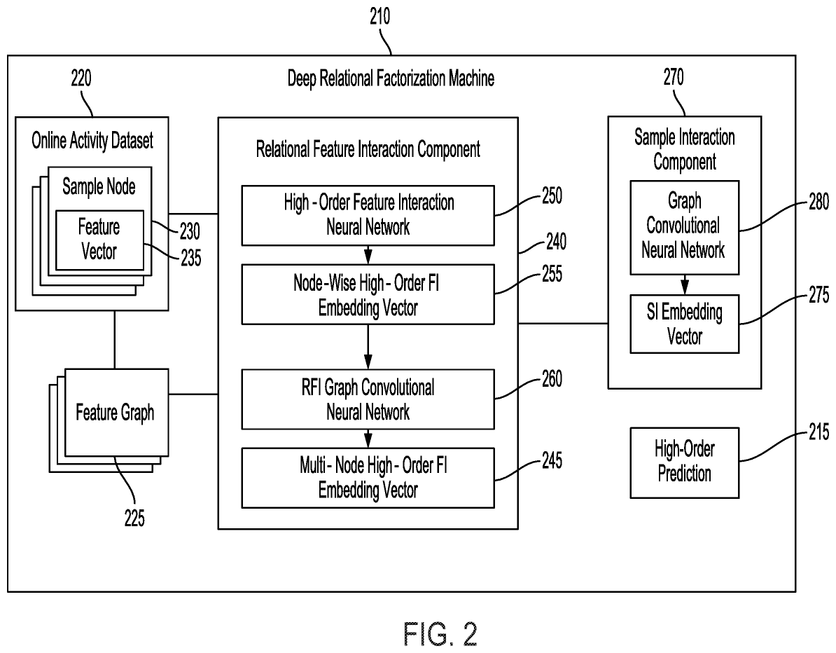

FIG. 2 is a diagram depicting an example of a DRFM 210 that is capable of generating high-order interaction data. In some cases, the DRFM 210 is included in a computing environment that includes a DRFM system, such as the DRFM system 110 depicted in FIG. 1. In FIG. 2, the DRFM 210 includes a relational feature interaction component 240 and an SI component 270. The DRFM 210 can determine high-order interaction data based on output data provided by one or more of the RFI component 240 or the SI component 270. Additionally or alternatively, the DRFM 210 can be capable of generating a prediction, such as a high-order prediction 215, based on the determined high-order interaction data.

In some implementations, the DRFM 210 accesses digital activity data, such as an online activity dataset 220. The online activity dataset 220 can be received from one or more data sources, such as the data repository 105 depicted in FIG. 1. The online activity dataset 220 can be, for example, one or more of a large dataset, a high-cardinality dataset, or a sparse dataset. In some cases, the online activity dataset 220 can include (or otherwise indicate) one or more data records representing sample nodes, such as a sample node 230. Additionally or alternatively, each of the sample nodes in the dataset 220 can include (or otherwise indicate) a respective feature vector, such as a feature vector 235 that is included in the sample node 230. Each feature vector can include one or more binary features representing digital activities that could be performed by a respective computing device associated with the respective sample node. For example, the feature vector 235 can include multiple binary features representing digital activities that can be performed by a particular computing device associated with the sample node 230.

In some implementations, the DRFM 210 is configured to generate one or more additional data structures based on the online activity dataset 220. In FIG. 2, the DRFM 210 can generate one or more feature graphs based on the sample nodes in the online activity dataset 220. For example, the DRFM 210 generates a feature graph 225 based on the sample node 230. In some cases, each feature graph generated by the DRFM 210 is based on a respective feature vector included in a respective one of the sample nodes in the dataset 220. Additionally or alternatively, each feature graph generated by the DRFM 210 is a concurrence graph, such as a concurrence graph in which a column (or row) associated with a particular feature has a value at each row (or column) indicating whether an additional feature is present in the feature graph. For example, the feature graph 225 can include multiple rows and columns, in which each column is associated with a respective feature included in the feature vector 235. Additionally or alternatively, each column in the feature graph 225 includes rows having values that indicate whether an additional feature of the feature vector 235 has a value that is defined (e.g., 1, 0) or undefined (e.g., NULL). In some cases, a path within a feature graph (e.g., a path indicating a connection among values in the graph) can indicate an interaction among features indicated in the graph. A non-limiting example of a concurrence feature graph is described in regards to Equation 3.

In some cases, such as if the online activity dataset 220 is a large dataset, each of the feature graphs generated by the DRFM 210 can be a large-data graph (e.g., a graph that includes large data). For example, if the feature vector 235 represents millions of online activities, the associated feature graph 225 can include millions of columns or rows, such as a respective column associated with each respective feature representing one of the online activities.

In FIG. 2, the DRFM 210 provides one or more of the online activity dataset 220 and the generated feature graphs (including feature graph 225) to the RFI component 240. Based on the dataset 220 and the feature graphs, the RFI component 240 can generate high-order FI data, such as a high-order feature interaction embedding vector 245. In some implementations, the RFI component 240 includes one or more neural networks that are configured to provide at least a portion of the high-order FI data. For example, the RFI component 240 includes a high-order feature interaction neural network 250 that is configured to determine, based on the feature graph for each sample node included in the online activity dataset 220, high-order FI data. In some cases, the high-order FI neural network 250 determines the high-order FI data based on paths among features indicated in a feature graph. For example, based on a path of three or more values in the feature graph 225 (e.g., a column having three or more entries with the value 1), the neural network 250 determines that the sample node 230 has a high-order feature interaction among the three or more binary features associated with the graph values included in the path. In some cases, determining high-order feature interactions for a particular sample node provides an improved understanding of interactions between or among features for the particular sample node.

Additionally or alternatively, the high-order FI neural network 250 can be configured to generate at least one embedding vector representing the high-order FI data, such as a node-wise high-order FI embedding vector 255. In some cases, the neural network 250 can generate a particular node-wise high-order FI embedding vector for each respective sample node included in the online activity dataset 220. For instance, the embedding vector 255 can represent the high-order FI data for the sample node 230. In some cases, an embedding vector that represents high-order FI data for a particular sample node can describe feature interactions for the particular sample node with improved accuracy, as compared to an additional embedding vector that represents pairwise FI data (e.g., omitting high-order FI data).

In some implementations, the RFI component 240 includes an RFI graph convolutional neural network 260 that is configured to determine, based on the node-wise high-order FI embedding vector 255 for each particular sample node in the online activity dataset 220, multi-node high-order FI data. In some cases, the RFI graph convolutional neural network 260 determines the multi-node high-order FI data for a particular sample node based on node-wise high-order FI data for the particular sample node and each additional sample node that is a neighbor to (e.g., is connected to, shares a vertex with) the particular sample node. For example, the neural network 260 can determine that the sample node 230 is associated with a multi-node high-order feature interaction, such as a high-order feature interaction that is included in the sample node 230 and in one or more additional sample nodes that neighbor the sample node 230 (e.g., multiple neighboring nodes having a particular high-order feature interaction). In some cases, determining multi-node high-order feature interactions provides an improved understanding of interactions between or among sample nodes that each have a particular high-order feature interaction.

Additionally or alternatively, the RFI graph convolutional neural network 260 can be configured to generate at least one embedding vector representing the multi-node high-order FI data, such as a multi-node high-order FI embedding vector 245. In some cases, the neural network 260 can generate a particular multi-node high-order FI embedding vector for each respective sample node included in the online activity dataset 220. For instance, the embedding vector 245 can represent the multi-node high-order FI data for the sample node 230. In some cases, an embedding vector that represents multi-node high-order FI data can describe sample interactions with improved accuracy as compared to SI data that does not utilize high-order feature interactions. For example, an embedding vector that represents multi-node high-order FI data can more accurately represent sample interactions between or among sample nodes that each have a particular high-order feature interaction.

In some implementations, one or more of the embedding vectors 255 or 245 are included in output data provided by the RFI component 240. For example, one or more of the embedding vectors 255 or 245 could be included in a high-order FI embedding vector, such as the high-order FI embedding vector 145 described in regards to FIG. 1.

In FIG. 2, the DRFM 210 provides output data from the RFI component 240 to the SI component 270. For example, the multi-node high-order FI embedding vector 245 can be provided to the SI component 270. In some implementations, the SI component 270 includes a graph convolutional neural network 280 that is configured to determine, based on high-order FI data included in the embedding vector 245, SI data for one or more sample nodes included in the online activity dataset 220. Additionally or alternatively, the graph convolutional neural network 280 can be configured to generate at least one embedding vector representing the SI data, such as a sample interaction embedding vector 275. In some cases, the graph convolutional neural network 280 generates a particular SI embedding vector for each respective sample node included in the online activity dataset 220. For example, based on the high-order FI data for sample node 230 (e.g., one or more of the embedding vectors 255 or 245), the graph convolutional neural network 280 may generate the SI embedding vector 275 describing sample interactions of the sample node 230 with one or more additional sample nodes included in the online activity dataset 220. In some cases, determining SI data based on high-order feature interactions provides an improved understanding of interactions between or among sample nodes that each have a particular high-order feature interaction. For example, an SI embedding vector that is determined based on high-order FI data can more accurately represent sample interactions between or among sample nodes that each have a particular high-order feature interaction.

In some implementations, one or more of the SI embedding vector 275 is included in output data provided by the SI component 270. For example, one or more of the SI embedding vector 275 (e.g., for multiple respective nodes in the dataset 220) could be included in the SI embedding vector 175 described in regards to FIG. 1.

In FIG. 2, the DRFM 210 generates the high-order prediction 215 based on output data from one or more of the RFI component 240 or the SI component 270. In some cases, the high-order prediction 215 is based on a combination of one or more high-order FI embedding vectors or SI embedding vectors. Additionally or alternatively, the high-order prediction 215 could include, for multiple sample nodes included in the online activity dataset 220, a respective high-order prediction for each particular sample node. For example, the DRFM 210 could generate the high-order prediction 215 for the sample node 230, based on a combination of the multi-node high-order FI embedding vector 245 and the SI embedding vector 275. In some cases the high-order prediction 215 can be provided to an additional computing system, such as the prediction computing system 190 described in regards to FIG. 1.

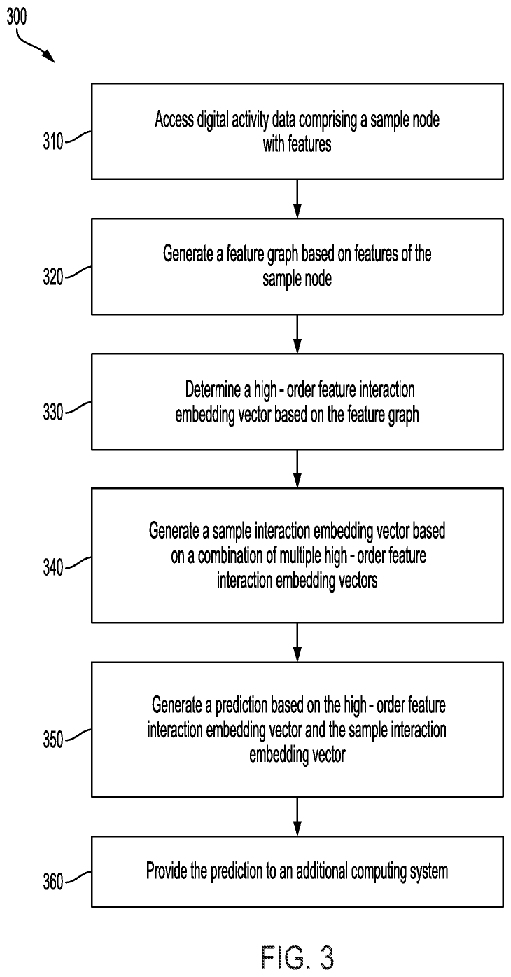

FIG. 3 is a flow chart depicting an example of a process 300 for generating high-order interaction data. In some embodiments, such as described in regards to FIGS. 1-2, a computing device executing a deep relational factorization machine implements operations described in FIG. 3, by executing suitable program code. For illustrative purposes, the process 300 is described with reference to the examples depicted in FIGS. 1-2. Other implementations, however, are possible.

At block 310, the process 300 involves accessing digital activity data, such as by a DRFM. Additionally or alternatively, the digital activity data comprises one or more sample nodes that include one or more features, such as binary features included in a respective feature vector for each sample node. In some cases, the digital activity data is online activity data, such as data describing online activities performed by one or more computing devices. For example, the DRFM system 110 accesses the online activity dataset 120, including the sample node 130 with feature vector 135. In some embodiments, the accessed digital activity data is one or more of large data, high-cardinality data, or sparse data.

At block 320, the process 300 involves generating a feature graph for a sample node included in the accessed digital activity data. For example, based on the feature vector 235, the DRFM 210 generates the feature graph 225 associated with the sample node 230. In some cases, the generated feature graph is a concurrence feature graph indicating a path among multiple features of the sample node.

In some embodiments, one or more operations related to block 320 may be omitted. For example, a deep relational factorization machine could provide the accessed digital activity data to one or more of an RFI component or an SI component without a feature graph.

In some embodiments, one or more operations described herein with respect to blocks 330-350 can be used to implement one or more steps for computing a high-order prediction. For instance, at block 330, the process 300 involves determining a feature interaction embedding vector, such as the high-order FI embedding vector 145. Additionally or alternatively, one or more high-order FI embedding vectors may be determined by an RFI component included in the DRFM. In some cases, the high-order FI embedding vector for a particular sample node is determined based on the feature graph associated with the particular sample node. For instance, the RFI component 240 can generate one or more of the high-order FI embedding vectors 255 or 245 based on the feature graph 225 associated with the sample node 230. In some cases, the high-order FI embedding vector can indicate a high-order feature interaction among three or more binary features included in the feature vector of the particular sample node. In some cases, one or more operations described with respect to block 330 can be used to implement a step for determining a high-order FI embedding vector that describes high-order feature interactions. Additionally or alternatively, one or more operations described with respect to block 330 can be used to implement a step for concatenating multiple high-order FI embedding vectors, such as multiple high-order FI embedding vectors associated with respective sample nodes or respective feature graphs.

At block 340, the process 300 involves determining an SI embedding vector, such as the SI embedding vector 175, based on one or more feature interaction vectors. In some cases, the SI embedding vector for a particular sample node is determined based on the high-order FI embedding vector associated with the particular sample node. Additionally or alternatively, the SI embedding vector is based on a combination of multiple high-order FI embedding vectors. For example, the SI embedding vector for the particular sample node can be determined based on a combination of the high-order FI embedding vector for the particular node with an additional high-order FI embedding vector for an additional node in the accessed digital activity data. In some cases, one or more SI embedding vectors may be determined by an SI component included in the DRFM. For instance, the SI component 270 can generate the SI embedding vector 275 associated with the sample node 230. Additionally or alternatively, the SI embedding vector 275 can be based on a combination of the multi-node high-order FI embedding vector 245 and an additional multi-node high-order FI embedding vector associated with an additional sample node from the online activity dataset 220. In some cases, one or more operations described with respect to block 340 can be used to implement a step for generating an SI embedding vector that describes sample interactions among subsets of the accessed digital activity data, such as among multiple sample nodes. Additionally or alternatively, one or more operations described with respect to block 340 can be used to implement a step for concatenating multiple SI embedding vectors.

At block 350, the process 300 involves generating, such as by the DRFM, a prediction based on the FI embedding vector and the SI embedding vector. Additionally or alternatively, the prediction can indicate a probability of an additional digital activity, such as by a computing device associated with the particular sample node, based on the high-order feature interactions and the sample interactions for the particular sample node. For example, the DRFM 210 can generate the high-order prediction 215 based on a combination of the high-order FI embedding vector 245 and the SI embedding vector 275. In some cases, the high-order prediction 215 can be based on a combination of the multi-node high-order FI embedding vector 245 and the SI embedding vector 275. Additionally or alternatively, the high-order prediction 215 can indicate a probability of an additional digital activity by a computing device associated with the sample node 230. In some cases, one or more operations described with respect to block 350 can be used to implement a step for computing a high-order prediction indicating a probability of an additional digital activity, such as a high-order prediction based on one or more of a feature graph, a high-order FI embedding vector, an SI embedding vector, or other data structures described in regards to the process 300.

At block 360, the process 300 involves providing the prediction to one or more additional computing systems. For example, the DRFM 210 can provide the high-order prediction 215 to an additional computing system, such as the prediction computing system 190. In some embodiments, the one or more additional computing systems are configured to perform one or more digital activities based on the received prediction. Additionally or alternatively, the one or more additional computing systems are configured to provide the received prediction (or data describing the received prediction) via a user interface, such as via the user interface 195.

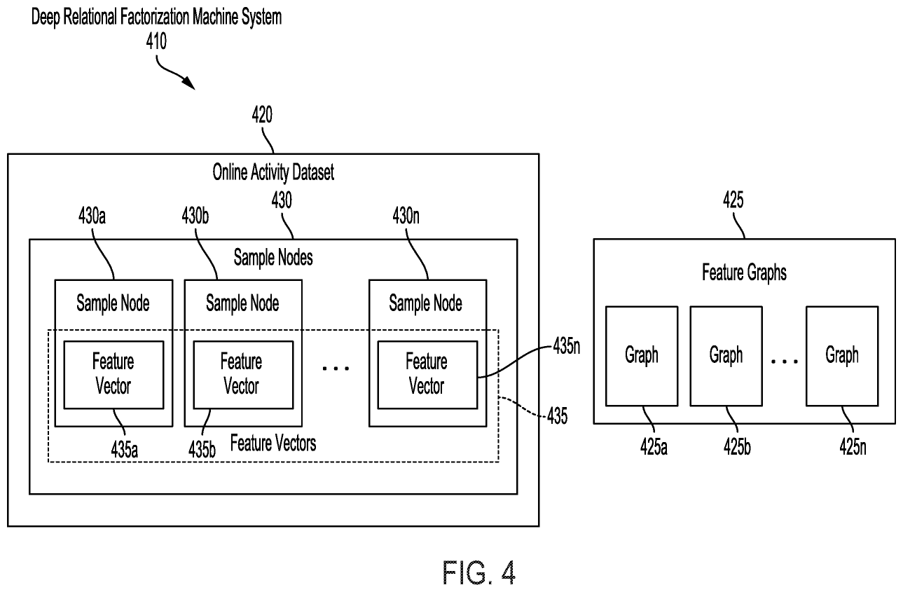

FIG. 4 is a diagram depicting an example of a DRFM system 410 that can generate (or otherwise receive) one or more data structures that can represent one or more of a sample node, a feature vector, or a feature graph. In some cases, the DRFM system 410 generates or receives one or more of the example data structures based on accessed digital activity data, such as described in regards to FIG. 1. For instance, the DRFM 410 can receive a dataset that includes one or more samples nodes or features vectors. Additionally or alternatively, the DRFM system 410 can generate, based on the accessed digital activity data, one or more sample nodes, feature vectors, or feature graphs.

In some embodiments, the DRFM system 410 generates (or receives) an online activity dataset 420 based on the accessed digital activity data. In FIG. 4, the online activity dataset 420 includes multiple sample nodes 430, including a sample node 430a, a sample node 430b, and additional samples nodes including a sample node 430n. Each particular one of the sample nodes 430 can represent online activity performed by a particular computing device via a computing network. For instance, each one of the sample nodes 430 can be associated with a respective computing device, such as a personal computer, laptop, mobile computing device (e.g., smartphone, personal digital assistant), wearable computing device (e.g., smartwatch, fitness monitor). or another suitable type of computing device that can perform digital activities via a computing network.

Additionally or alternatively, the online activity dataset 420 includes multiple feature vectors 435, including a feature vector 435a, a feature vector 435b, and additional feature vectors including a feature vector 435n. Each of the feature vectors 430 is included in (or otherwise indicated by) a respective one of the sample nodes 430. For example, the sample node 430a includes the feature vector 435a, the sample node 430b includes the feature vector 435b, and the sample node 430n includes the feature vector 435n. Each particular one of the feature vectors 430 includes one or more features representing respective digital activities that can be performed by the computing device associated with the sample node of the particular feature vector. For instance, the features in a feature vector can represent online activities such as (without limitation) clicking on a link, loading an image or video, viewing a content item, reading a social media post, creating an online account, establishing a relationship (e.g., “following,” “friending”) with an additional online account, completing a purchase, or any other digital activity that includes communicating data among multiple computing devices. In some cases, the feature vectors 435 include binary features, such as binary features indicting that respective digital activities have been performed (e.g., binary value of 1) or not performed (e.g., binary value of 0) by a computing device associated with a sample node. Additionally or alternatively, the feature vectors 435 can include binary features with undefined values, such as binary features indicting respective digital activities that have not been presented to an associated computing device. For example, the feature vectors 435 may each include a binary feature indicating if a particular online video has been played to completion. If a particular computing device associated with the sample node 430a has never received the particular video, then the feature vector 435a may include the binary feature with an undefined value (e.g., indicating that the associated computing device has never received the particular video for that feature).

In some cases, a feature in the feature vectors 435 represents a digital activity that is performed between (or among) two or more computing devices that are associated with respective ones of the sample nodes 430, such as establishing a “following” relationship between two or more of the associated computing devices. Additionally or alternatively, a feature represents a digital activity that is performed between (or among) a computing device associated with one of the sample nodes 430 and an additional computing system (e.g., a server, an additional personal computing device) that is not associated with one of the sample nodes 430, such as viewing a video that is provided by an additional computing system unassociated with a sample node.

Based on the feature vectors 435, the DRFM system 410 generates (or otherwise receives) feature graphs 425, including a feature graph 425a, a feature graph 425b, and additional feature graphs including a feature graph 425n. Each of the feature graphs 425 is associated with a respective one of the feature vectors 435 and the associated one of sample nodes 430. For example, the feature graph 425a is generated based on the feature vector 435a, and is associated with the sample node 430a. Additionally or alternatively, the feature graphs 425b and 425n are based on the respective feature vectors 435b and 435n, and are associated with the respective sample nodes 435b and 435n. In some embodiments, each of the feature graphs 425 is a matrix data structure representing a concurrence feature graph, such as a concurrence feature graph in which each column is associated with a particular binary feature, and in which each row in a particular column indicates whether an additional feature (e.g., other than the feature for the particular column) has a defined value in the associated feature vector. For example, the feature graph 425a can have multiple columns, each column being associated with a respective feature in the feature vector 435a, in which each row in a particular column indicates whether an additional feature from the feature vector 435a is defined. In some cases, the feature graphs 425 include binary values indicating whether a particular feature is defined in the associated feature vectors 435. For example, the feature graphs 425 can include a value of 1 (or 0) for a feature that has a defined value, or a value of 0 (or 1) for an additional feature that has an undefined value.

In some cases, the online activity dataset 420 is one or more of a large dataset, a high-cardinality dataset, or a sparse dataset. Additionally or alternatively, one or more of the sample nodes 430, feature vectors 435, or feature graphs 425 are one or more of large data, high-cardinality data, or sparse data. For example, the sample nodes 430 may be large and high-cardinality data, including several million (or billion) sample nodes that are associated with several million (or billion) unique computing devices. Additionally or alternatively, the feature vectors 435 may be large data, such as several million (or billion) feature vectors associated with the sample nodes 430, each feature vector including billions of features representing billions of digital activities. Furthermore, the feature vectors 435 may be sparse data, in which about 90% or more of the billions of features have undefined values or values of 0. Additionally or alternatively, the feature graphs 425 may be large data, such as feature graphs having billions of columns and rows associated with the billions of features of the feature vectors 435. Furthermore, the feature graphs 425 may be sparse data, in which about 90% or more of the graph values indicate that the associated features are have undefined values or values of 0.

In some embodiments, a feature vector includes a matrix data structure that includes values for binary features represented by the feature vector. Equation 1 describes a non-limiting example of a feature vector.

X=[x₁,x₂, . . . ,xₙ]∈ [symbol] ^{d×n} Eq. 1

In Equation 1, a feature vector X belongs to a real domain [symbol] ^{d×n} having dimensions d and n. In some cases, the feature vector X includes node-wise feature vectors for n nodes, such as node-wise feature vectors x₁ through xₙ. Additionally or alternatively, each node-wise feature vector xᵢ includes d features, such as for a particular sample node. Equation 2 describes a non-limiting example of a node-wise feature vector xᵢ for a sample node i.

xᵢ=[x₁,x₂, . . . ,x_{d}]^{T}∈ [symbol] ^{d} Eq. 2

In Equation 2, the feature vector xᵢ includes d features, such as features x₁ through x_{d}. For convenience, and not by way of limitation, Equation 2 is annotated as a transposed matrix. In some cases, one or more of the features x₁ through x_{d} is a binary feature, such as described in regards to feature vectors 435. However, additional implementations are possible, such as a feature vector that includes non-binary values, or one or more features having additional vectors of values.

In some cases, a feature vector is a single-column (or single-row) matrix, in which each entry of the column (or row) represents a particular digital activity that may be performed by a computing device. For example, the DRFM system 410 can generate, for each one of the feature vectors 435, a respective data structure including a single-column matrix, in which each row of the single-column matrix includes a value for a particular digital activity performed by the respective computing device. In some cases, the values for a particular feature, such as one or more of the features x₁ through x_{d}. could have an undefined value.

In some embodiments, a feature graph, such as a concurrence feature graph, is generated based on a feature vector. In some cases, the feature graph may be of size d×d, based on the feature vector including d features. Additionally or alternatively, the feature graph includes an additional matrix data structure that includes values for concurrence of features represented by the feature vector. As a non-limiting example, a DRFM system, such as the DRFM system 410, may receive a feature vector x_{A}=[0,1,0,1,1,0,0] including binary features. In the example feature vector x_{A}, the second, fourth, and fifth features co-occur (e.g., have values of 1). Based on the feature vector x_{A}, the DRFM system can generate an example concurrence feature graph G_{A}, such as described in Equation 3.

$${G}_{A} = [ \begin{matrix}1 & 0 & 0 & 0 & 0 & 0 & 0 \\ 0 & 1 & 0 & 1 & 1 & 0 & 0 \\ 0 & 0 & 1 & 0 & 0 & 0 & 0 \\ 0 & 1 & 0 & 1 & 1 & 0 & 0 \\ 0 & 1 & 0 & 1 & 1 & 0 & 0 \\ 0 & 0 & 0 & 0 & 0 & 1 & 0 \\ 0 & 0 & 0 & 0 & 0 & 0 & 1\end{matrix} ] \qquad Eq . 3$$

In Equation 3, each column corresponds to a particular one of the features in the feature vector x_{A}. Additionally or alternatively, for each particular column, the values of each row indicate whether the corresponding feature is concurrent with (e.g., occurs with) an additional feature of the feature vector x_{A}. For example, the first feature of the feature vector x_{A}=[0,1,0,1,1,0,0] has a value of 0. In the example concurrence feature graph G_{A}, the first column (e.g., corresponding to the first feature) has values of 0 in each row except the first row, indicating that the first feature does not co-occur with any feature in addition to itself (e.g., the first row). Continuing in the example graph G_{A}, the second column (e.g., corresponding to the second feature) has values of 1 in the second, fourth, and fifth rows, indicating that the second feature co-occurs with itself (e.g., the second row) and also with the fourth and fifth features (e.g., the fourth and fifth rows). In some cases, a concurrence feature graph, such as the graph G_{A}, is a symmetrical graph, such that the transpose of the concurrence feature graph is identical to the concurrence feature graph (e.g., G_{A}=[G_{A}]^{T}.

For convenience, and not by way of limitation, the example feature vector x_{A} includes values of 1 and 0, and the example concurrence feature graph G_{A} includes values of 1 that indicate a concurrence between features having a value of 1. However, additional implementations are possible. For instance, an example feature vector may include feature values of 1 indicating that a digital activity has been performed, feature values of 0 indicating that the digital activity has not been performed, and undefined feature values indicating that no information is available regarding the digital activity. Based on this example feature vector, an example concurrence feature graph may include graph values of 1 indicating a concurrence between feature values of 1 and/or 0 (e.g., digital activities that are performed and digital activities that are not performed) and graph values of 0 indicating non-concurrence for undefined feature values (e.g., information is not available regarding digital activities). As a non-limiting example, a concurrence may be determined between a first feature indicating that a computing device accessed a video (e.g., a feature value of 1) and a second feature indicating that the computing device did not complete playback of the video (e.g., a feature value of 0).

In some embodiments, a DRFM system includes one or more neural networks configured to generate high-order FI data based on one or more feature graphs. For example, an RFI component included in a DRFM system can generate, for each one of multiple sample nodes, a high-order FI embedding vector based on a respective feature graph for each sample node. In some cases, the RFI component includes a multi-layer neural network that is configured to generate the high-order FI embedding vector for each particular node.

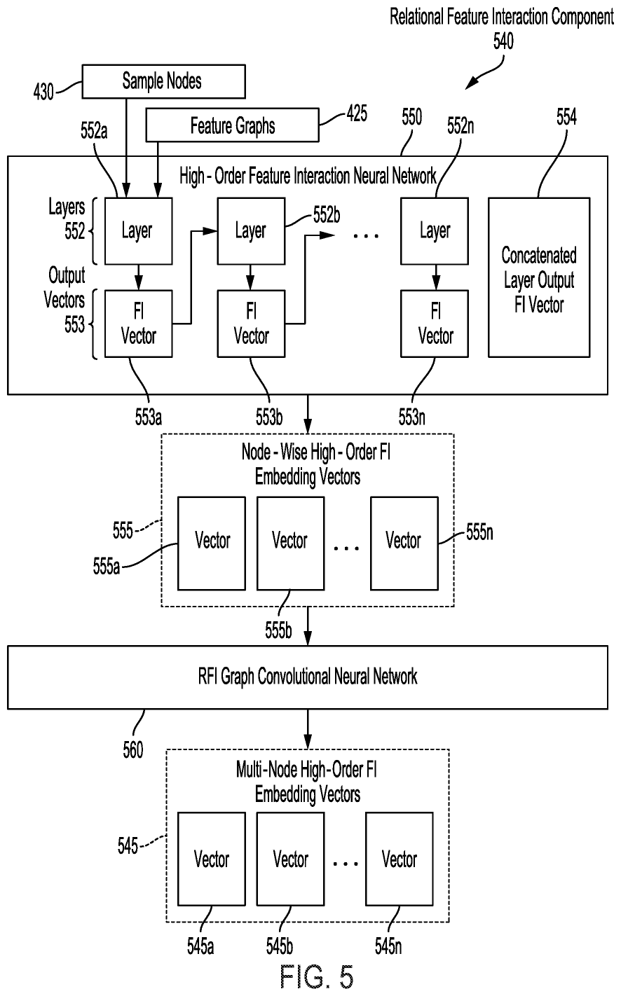

FIG. 5 is a diagram depicting an example of one or more neural networks that may be included in an RFI component 540. In some cases, the RFI component 540 is included in a DRFM system, such as the DRFM system 410. Additionally or alternatively, the RFI component 540 can receive one or more of sample nodes or feature graphs. For example, the RFI component 540 can receive the sample nodes 430, the feature vectors 435, and the feature graphs 425 as described in regards to FIG. 4.

In some embodiments, the RFI component 540 includes a high-order FI neural network 550 that is configured to determine one or more high-order FI embedding vectors, such as node-wise high-order FI embedding vectors 555. Additionally or alternatively, the neural network 550 can determine the node-wise high-order FI embedding vectors 555 based on one or more sample nodes or feature graphs, such as the sample nodes 430 and feature graphs 425. In some cases, the embedding vectors 555 include a respective embedding vector for each sample node, such as node-wise high-order FI embedding vectors 555a, 555b, or 555n. For example, the neural network 550 can generate the embedding vector 555a for the sample node 430a, based on the feature vector 435a and feature graph 425a. Additionally or alternatively, the neural network 550 can generate the embedding vector 555b for the sample node 430b, based on the feature vector 435b and feature graph 425b; the embedding vector 555n for sample node 430n, based on the feature vector 435n and feature graph 425n; and additional node-wise high-order FI embedding vectors for additional nodes in the sample nodes 430, based on additional respective feature vectors and feature graphs.

In FIG. 5, the high-order FI neural network 550 includes one or more layers that are capable of determining high-order interactions between or among multiple features. For example, the neural network 550 includes layers 552, including an initial layer 552a, a subsequent layer 552b, and additional subsequent layers including a final layer 552n. In some cases, the layers 552 are arranged sequentially, such that an output of a previous layer is received as an input by a subsequent layer. For example, an output of the layer 552a is received as an input by layer 552b, an output of the layer 552b is received as an input by an additional subsequent layer, and the layer 552n receives, as an input, an output from an additional layer that is previous to the layer 552n.

In some embodiments, each of the layers 552 includes a model that can generate high-order FI data for a sample node. Based on the model, each of the layers 552 can determine the high-order FI data for an input that represents one or more of features or interactions among features. Additionally or alternatively, each of the layers 552 can output an embedding vector representing the high-order FI data, such as output high-order FI embedding vectors 553. The output FI vectors 553 can be based on one or more of an input from a previous layer, a feature vector, or a feature graph. In some cases, a quantity of the layers 552 can be determined based on a parameter of the neural network 550, such as a parameter indicating a desired accuracy of the high-order FI data generated by the layers 552. Additionally or alternatively, the quantity of the layers 552 can be modified, such as based on an input received by one or more of the RFI component 540 or the DRFM system 410.

For example, the RFI component 540 (or the neural network 550) provides, as an input to the initial layer 552a, one or more of the sample nodes 430 and the feature graphs 425. The input to the layer 552a can include the feature vectors 435 in the sample nodes 430, as described in regards to FIG. 4. Based on the inputs, the layer 552a determines high-order FI data and generates an output FI embedding vector 553a representing the high-order FI data. In some cases, the layer 552a generates a respective output FI embedding vector for each node in the sample nodes 430. For instance, a first output FI embedding vector can be generated for sample node 430a, based on feature vector 435a and the feature graph 425a, and a second output FI embedding vector can be generated for sample node 430b, based on feature vector 435b and the feature graph 425b.

Additionally or alternatively, the output FI vector 553a is provided to the layer 552b as an input. Based on the information represented by the vector 553a, the layer 552b determines or modifies the high-order FI data for each respective sample node, and generates an output FI embedding vector 553b representing additional high-order FI data for each respective node. In some cases, the high-order FI data and the output FI vector 553b are further based on additional information from the sample nodes 430 or the feature graphs 425. For instance, the layer 552b determines the output FI vector 553b for each sample node based on the respective feature vector and feature graph for each sample node.

In FIG. 5, the output FI vector 553b is provided to a subsequent one of the layers 552. In some embodiments, each subsequent one of the layers 552 determines or modifies additional high-order FI data for each sample node, based on the output FI vector (e.g., from the previous layer), the feature vector, and the feature graph for each respective sample node. The final layer 552n generates a output FI embedding vector 553n representing the high-order FI data accumulated from some or all of the layers 552. In some cases, the output FI vector 553n represents the high-order FI data for each sample node.

In some cases, the neural network 550 generates a combination of one or more of the output FI embedding vectors 553 from the layers 552. For example, the neural network 550 generates a concatenated layer output FI vector 554, based on a concatenation of the output FI vectors 553a, 553b, and each additional output FI vector including vector 553n. In some cases, the neural network 550 generates a respective concatenated layer output FI vector 554 for each node in the sample nodes 430. FIG. 5 depicts the combination of the output FI vectors 553 as a concatenation, but other combinations are possible. For example, the neural network 550 could generate a combination of one or more output FI vectors based on a sum, a product, a matrix having multiple rows or columns corresponding to output FI vectors, or any other suitable combination.

Based on the high-order FI data generated by the layers 552, the high-order FI neural network 550 generates the node-wise high-order FI embedding vectors 555. In some cases, the vectors 555 include a node-wise high-order FI embedding vector for one or more respective sample nodes. For example, the vectors 555 include the node-wise high-order FI embedding vector 555a that is associated with sample node 430a, based on a group of the output FI vectors 553 describing high-order FI data for the sample node 430a. Additionally or alternatively, the vectors 555 include the node-wise high-order FI embedding vector 555b associated with sample node 430b, based on output FI vectors 553 for the sample node 430b; the node-wise high-order FI embedding vector 555n associated with sample node 430n, based on output FI vectors 553 for the sample node 430n; and additional node-wise high-order FI embedding vectors for additional sample nodes, based on respective groups of the output FI vectors 553 describing high-order FI data for the respective sample nodes.

In some cases, one or more of the node-wise high-order FI embedding vectors 555 are based on a combination of the output FI embedding vectors 553, such as the concatenated layer output FI vector 554. For example, each of the embedding vectors 555a, 555b, and 555n can be based on a respective concatenated layer output vector that is associated with the respective sample node 430a, 430b, and 430n.

In some embodiments, a high-order FI neural network is configured to determine one or more high-order FI embedding vectors based on one or more sample nodes or feature graphs. For example, the high-order FI neural network 550 is configured to determine the node-wise high-order FI embedding vectors 555 based on the sample nodes 430 and feature graphs 425. Additionally or alternatively, the high-order FI neural network can include one or more layers configured to output high-order FI vectors, such as the layers 552 in the neural network 550. Equations 4.1, 4.2, 4.3, and 4.4 (collectively referred to herein as Equation 4) describe a non-limiting example of a model for determining high-order interactions among features of a sample node.

vₚ^{l}=graph_conv(vₚ⁰,v_{q}^{l-1}) Eq. 4.1

vₚ⁰=σ(Wvₚ⁰) Eq. 4.2

vₚ^{l}=σ(Wvₚ^{l}) Eq. 4.3

hᵢ^{l}=Σ_{p:x}_{_{i,p=v}}ₚ^{l} Eq. 4.4

In Equation 4, an output high-order FI embedding vector hᵢ^{l} is determined for a sample node i, via a layer l. In some cases, the high-order FI embedding vector hᵢ^{l} is a hidden vector, indicating a hidden state of a layer in a neural network (e.g., the neural network 550). The output high-order FI embedding vector hᵢ^{l} can be determined based on a feature vector, such as a node-wise feature vector xᵢ described in regards to Equations 1 and 2. In some cases, the high-order FI neural network 550 can include multiple layers 552 having respective models based on Equation 4. The multiple layers 552 can determine the output high-order FI embedding vectors 553, for example, by determining a respective output high-order FI embedding vector hᵢ^{l} by each layer l in the layers 552. In Equation 4.1, a layer l determines a feature relation vector vₚ^{l} that represents a relation between a feature p and an additional feature q. In some cases, the features p and q are binary features included in the node-wise feature vector xᵢ. In Equation 4.1, the feature relation vector vₚ^{l} is determined based on a modified graph convolutional operation graph_conv(vₚ⁰, v_{q}^{l-1}) between an original feature relation vector vₚ⁰ (e.g., a feature relation vector from a zero-th layer) and a previous feature relation vector v_{q}^{l-1} received from a previous layer l−1. For example, the layer 552b can determine the feature relation vector vₚ^{l} based on a modified graph convolutional operation between the original feature relation vector vₚ⁰ and the previous feature relation vector v_{q}^{l-1} received from the previous layer 552a.

In Equation 4, an initial layer (e.g., l=1) can determine the feature relation vector vₚ^{l} based on a modified graph convolutional operation of the original feature relation vector vₚ⁰ (e.g., the vector vₚ⁰ convolved with itself). In some cases, the original feature relation vector vₚ⁰ is based on one or more feature vectors associated with the sample node i, such as the feature vectors 435. In Equation 4.2, the original feature relation vector vₚ⁰ is modified based on a weighting factor W and a sigmoid function σ. In some cases, the sigmoid function a performs a non-linear transformation of the product of the weighting factor W and the original feature relation vector vₚ⁰. In some cases, the weighting factor W has a particular value for each sample node i.

In some embodiments, the original feature relation vector vₚ⁰, as modified in Equation 4.2, is provided to a subsequent layer. Additionally or alternatively, the subsequent layer may perform operations in Equation 4 utilizing the original feature relation vector vₚ⁰ as modified. For instance, the initial layer 552a can determine the feature vector vₚ^{l} based on a modified graph convolutional operation of the original feature relation vector vₚ⁰ (e.g., the feature vectors 435). Additionally or alternatively, the layer 552a can modify the original feature relation vector vₚ⁰ based on Equation 4.2, and provide the feature relation vector vₚ^{l} and the original feature relation vector vₚ⁰ as modified to the subsequent layer 552b.

In Equation 4, a layer l can determine the feature relation vector vₚ^{l} based on a modified graph convolutional operation between the original feature relation vector vₚ⁰ (including, but not limited to, the original feature relation vector vₚ⁰ as modified by Equation 4.2) and a previous feature relation vector v_{q}^{l-1}. In Equation 4.3, the feature relation vector vₚ^{l} is modified based on a weighting factor W and a sigmoid function a, such as a sigmoid function indicating a non-linear transformation. In Equation 4.3, the weighting factor W and sigmoid function a may, but need not, be identical to the weighting factor W and sigmoid function a used in Equation 4.2. Additionally or alternatively, the weighting factor W may, but need not, have a particular value for each sample node i. In some cases, the feature relation vector vₚ^{l}, as modified in Equation 4.3, is provided to a subsequent layer. Additionally or alternatively, the subsequent layer may perform operations in Equation 4 utilizing the feature relation vector vₚ^{l} as modified. For instance, the layer 552b can determine the feature relation vector vₚ⁰ based on a modified graph convolutional operation between the original feature relation vector vₚ⁰ and a previous feature relation vector v_{q}^{l-1} received from layer 552a. Additionally or alternatively, the layer 552b can modify the feature relation vector vₚ^{l} based on Equation 4.3, and provide the feature relation vector vₚ^{l} as modified to a subsequent one of the layers 552.

In Equation 4.4, a layer l can determine the output high-order FI embedding vector hᵢ^{l} based on the feature relation vector vₚ^{l} from Equation 4.1. Further in Equation 4.4, the output high-order FI embedding vector hᵢ^{l} is determined based on a sum of the feature relation vector vₚ^{l} over the features p. In some cases, the sum is summed over multiple features p: xᵢ where p=1. For example, the sum is based on the feature relation vector vₚ^{l} for binary features p included in the feature vector xᵢ, where the sum includes features p that have a value of 1 in the feature vector xᵢ and excludes features p that have values other than 1 (e.g., value of 0, undefined value).

In some embodiments, a high-order FI neural network includes one or more layers configured to determine a feature relation vector based on a modified graph convolutional operation. Equation 5 describes a non-limiting example of a modified graph convolutional operation for determining a feature relation vector. In some cases, a high-order FI neural network, such as one or more layers 552 included in the high-order FI neural network 550, is configured to determine a feature relation vector based on Equation 5.

graph_conv(vₚ⁰,v_{q}^{l-1})=vₚ⁰∘Σ_{q:G}_{_{pq}}₌₁v_{q}^{l-1} Eq. 5

In some embodiments, a layer l that is configured to determine a feature relation vector vₚ^{l}, such as described in regards Equation 4.1, determines the vector vₚ^{l} based on Equation 5. In Equation 5, a modified graph convolutional operation is described between an original feature relation vector vₚ⁰ and a feature relation vector v_{q}^{l-1}. In some cases, the feature relation vector v_{q}^{l-1} is received from a previous layer l−1. In Equation 5, the modified graph convolutional operation is based on a sum of the feature relation vector v_{q}^{l-1} over the features q. Further in Equation 5, the modified graph convolutional operation is based on an element-wise product between the sum of the feature relation vector v_{q}^{l-1} and the original feature relation vector vₚ⁰. In some cases, the features p and q are binary features included in the feature vector xᵢ.

In some cases, one or more operations related to Equation 5 are performed based on a feature graph G, such as the non-limiting example concurrence graph G_{A} described in regards to Equation 3. For example, one or more of the layers 552 can determine a respective feature relation vector vₚ^{l} based on a respective one of the feature graphs 425. In Equation 5, the sum of the feature relation vector v_{q}^{l-1} can be summed over multiple features q:G where G_{pq}=1. For example, the sum is based on the feature relation vector v_{q}^{l-1} for binary features q included in the feature graph G, where the sum includes vectors v_{q}^{l-1} at the graph entries G_{pq} that have a value of 1 (e.g., the graph G indicates a concurrence between features p and q) and excludes vectors vi at the graph entries G_{pq} that have a value of other than 1 (e.g., the graph G does not indicate concurrence between features p and q).

In some cases, a high-order FI neural network configured based on one or more of Equations 4 or 5 can determine high-order FI data with improved computational efficiency, such as by reducing or removing computations related to features that are not present or undefined. For example, a layer l that is configured to determine the output high-order FI embedding vector hᵢ based on Equation 4.4 can more efficiently perform a summation of multiple features p: xᵢ where p=1, such as by omitting one or more operations related to features p that are excluded from the summation, e.g., features p with values other than 1. Additionally or alternatively, a layer l that is configured to determine the feature relation vector vₚ^{l} based on Equation 5 can more efficiently perform a summation of multiple features q:G where G_{pq}=1, such as by omitting one or more operations related to feature relation vectors v_{q}^{l-1} that are excluded from the summation, e.g., at graph entries G_{pq} with a value of other than 1.

In some embodiments, the RFI component 540 includes an RFI graph convolutional neural network 560 that is configured to determine one or more high-order FI embedding vectors, such as multi-node high-order FI embedding vectors 545. Additionally or alternatively, the neural network 560 can determine the multi-node embedding vectors 545 based on high-order FI data determined by the high-order FI neural network 550. For example, the RFI component 540 can provide one or more of the node-wise high-order FI embedding vectors 555 as an input to the RFI graph convolutional neural network 560. Based on the embedding vectors 555, the neural network 560 can generate a respective multi-node embedding vector for each sample node, such as multi-node high-order FI embedding vectors 545a, 545b, or 545n. For example, the neural network 560 can generate the multi-node high-order FI embedding vector 545a for the sample node 430a, based on the node-wise high-order FI embedding vector 555a. Additionally or alternatively, the neural network 560 can generate the multi-node FI embedding vector 545b for the sample node 430b, based on the node-wise FI embedding vector 555b; the multi-node FI embedding vector 545n for sample node 430n, based on the node-wise FI embedding vector 555n; and additional multi-node high-order FI embedding vectors for additional nodes in the sample nodes 430, based on additional respective node-wise FI embedding vectors from the vectors 555.

The RFI graph convolutional neural network 560 includes a model that is capable of performing a graph convolutional operation. In FIG. 5, the neural network 560 can be configured to perform the modeled graph convolutional operation for each sample node having one or more neighboring nodes, such as a sample node that has a relationship with one or more additional sample nodes. In some cases, a relationship between or among sample nodes is based on a relationship between or among computing devices (or online accounts corresponding to the computing devices) that are associated with the sample nodes, such as a “following” relationship, a “friend” relationship, a relationship among household devices (e.g., multiple devices used by one or more members of a particular household), or any other suitable relationship established between at least two computing devices.

In some embodiments, the neural network 560 generates the multi-node FI embedding vectors 545 for each sample node, based on the respective combined output FI embedding vectors for the node and neighboring nodes. For instance, the neural network 560 determines the multi-node FI embedding vector 545a based on the concatenated layer output FI vector 554 associated with sample node 430a (e.g., included in the node-wise FI embedding vector 555a). Additionally or alternatively, the vector 545a is determined based on the concatenated layer output FI vector 554 associated with sample nodes that are neighbors of the sample node 430a. For instance, the neural network 560 performs the modeled graph convolutional operation between (or among) the concatenated layer output FI vectors 554 for sample node 430a and each neighboring node of sample node 340a.

In some embodiments, an RFI graph convolutional neural network is configured to perform a graph convolutional operation on a combination of high-order FI embedding vectors output from multiple layers of a high-order FI neural network. For example, the RFI graph convolutional neural network 560 is configured to perform graph convolution on the concatenated layer output FI vector 554 from the output of layers 552 in the high-order FI neural network 550. Equation 6 describes a non-limiting example of a graph convolutional operation for combined high-order FI embedding vectors.

$${h}_{i}^{RFI} = \frac{1}{\sqrt{\vert 𝒩 ( i ) \vert}} {\sum }_{{i}^{′} ∈ 𝒩 ( i )} \frac{1}{\sqrt{\vert 𝒩 ( {i}^{′} ) \vert}} {h}_{{i}^{′}}^{FI} \qquad Eq . 6$$

In Equation 6, a multi-node high-order FI embedding vector hᵢ^{RFI} is determined for a sample node i. For example, the RFI graph convolutional neural network 560 can include a model based on Equation 6 to determine the multi-node FI embedding vectors 545. In Equation 6, the multi-node FI embedding vector hᵢ^{RFI} is determined based on the neighbor group [symbol] (i) for the sample node i. Further in Equation 6, the multi-node FI embedding vector hᵢ^{RFI} is determined based on the additional neighbor group [symbol] (i′) for an additional sample node i′, where the additional sample node i′ is a neighbor of the sample node i. For example, the multi-node FI embedding vector hᵢ^{RFI} is based on, for each neighbor node i′ of the sample node i, a square root operation performed on the value of the additional neighbor group [symbol] (i′) multiplied by the node-wise high-order FI embedding vector h_{i′}^{FI} for the neighbor sample node i′. In Equation 6, the products of the above-described multiplication operation for each neighbor node i′ are summed, and the summation is multiplied by an additional square root operation performed on the value of the neighbor group [symbol] (i) for the sample node i.

In some cases, an RFI graph convolutional neural network configured to use a model based on Equation 6 can generate a multi-node high-order FI embedding vector that represents relational (e.g., multi-node) feature interactions among multiple sample nodes (e.g., the neighbors of sample node i) based on the high-order feature interactions (e.g., vector h_{i′}^{FI}) of the multiple sample nodes. In some cases, an RFI graph convolutional neural network configured to use a model based on Equation 6 can generate multi-node high-order FI data that more accurately describes high-order feature interactions that are shared (or otherwise related) among two or more sample nodes.

In some embodiments, a DRFM system includes one or more neural networks configured to generate SI data, including high-order SI data, based on high-order FI data. For example, an SI component included in a DRFM system can generate, for each one of multiple sample nodes, an SI embedding vector based on a respective high-order FI embedding vector for each sample node. In some cases, the SI component includes a multi-layer neural network that is configured to generate the SI embedding vector for each particular node.

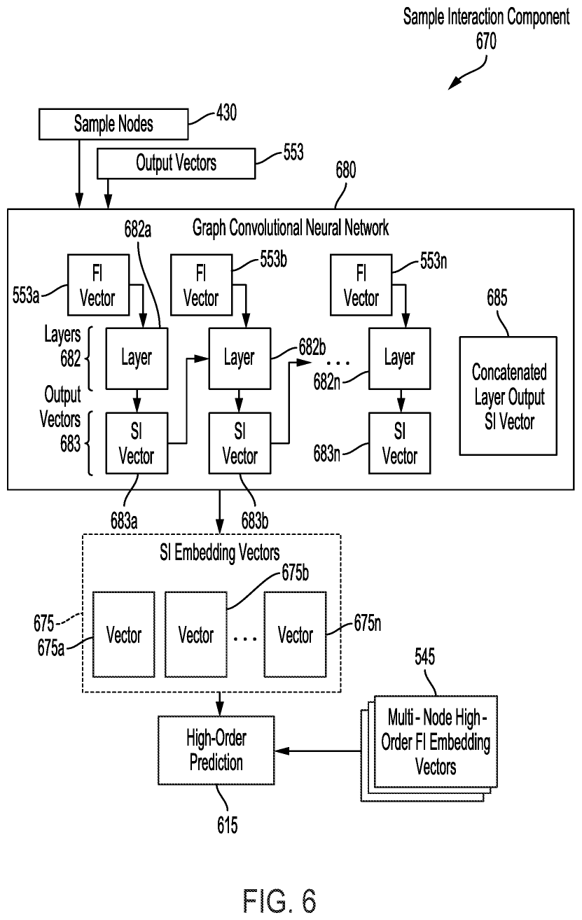

FIG. 6 is a diagram depicting an example of a neural network that may be included in an SI component 670. In some cases, the SI component 670 is included in a DRFM system, such as the DRFM system 410. Additionally or alternatively, the SI component 670 can receive one or more high-order feature interaction embedding vectors from an additional component in the DRFM system. For example, the SI component 670 can receive the output high-order FI embedding vectors 553 generated by the high-order FI neural network 550, as described in regards to FIG. 5. In some cases, the SI component 670 can receive the sample nodes 430, including the feature vectors 435.

In some embodiments, the SI component 670 includes a graph convolutional neural network 680 that is configured to determine one or more SI embedding vectors, such as SI embedding vectors 675. Additionally or alternatively, the neural network 680 can determine the SI embedding vectors 675 based on one or more high-order FI embedding vectors, such as the output high-order FI embedding vectors 553. In some cases, the embedding vectors 675 include a respective embedding vector for each sample node, such as SI embedding vectors 675a, 675b, or 675n. For example, the neural network 680 can generate the embedding vector 675a for the sample node 430a, based on the output high-order FI embedding vector 553a. Additionally or alternatively, the neural network 680 can generate the embedding vector 675b for the sample node 430b, based on the output FI embedding vector 553b; the embedding vector 675n for the sample node 430n, based on the output FI embedding vector 553n; and additional SI embedding vectors for additional nodes in the sample nodes 430, based on additional respective output high-order FI embedding vectors.

In FIG. 6, the graph convolutional neural network 680 includes one or more layers that are capable of determining interactions between or among multiple sample nodes. For example, the neural network 680 includes layers 682, including an initial layer 682a, a subsequent layer 682b, and additional subsequent layers including a final layer 682n. In some cases, the layers 682 are arranged sequentially, such that an output of a previous layer is received as an input by a subsequent layer. For example, and output of the layer 682a is received as an input by layer 682b, and output of the layer 682b is received as an input by an additional subsequent layer, and the layer 682n receives, as an input, and output from and an additional layer that is previous to the layer 682n.

In some embodiments, each of the layers 682 includes a model that can generate SI data for a sample node. Based on the model, each of the layers 682 can determine the SI data for an input that represents high-order interactions among binary features. Additionally or alternatively, each of the layers 682 can output embedding vector representing the SI data, such as output SI embedding vectors 683. The output SI vectors 683 can be based on one or more of an input from a previous layer, a high-order FI embedding vector, or one or more sample nodes.

In some cases, a quantity of the layers 682 can be determined based on a parameter of the neural network 680, such as a parameter indicating a desired accuracy of the SI data generated by the layers 682. Additionally or alternatively, the quantity of the layers 682 can be modified, such as based on an input received by one or more of the SI component 670 or the DRFM system 410.

For example, the SI component 670 provides, as an input to the initial layer 682a, the output FI vector 553a and one or more of the sample nodes 430. The input to the layer 682a can include the feature vectors 435 in the sample nodes 430, as described in regards to FIG. 4. Based on the inputs, the layer 682a determines SI data and generates an output SI embedding vector 683a representing the SI data. In some cases, the layer 682a generates a respective output SI embedding vector for each node in the sample nodes 430. For example, a first output SI embedding vector can be generated for sample node 430a, and a second output SI embedding vector can be generated for sample node 430b.

Additionally or alternatively, the output SI vector 683a is provided to the layer 682b as an input. Based on information represented by the vector 683a, the layer 682b determines or modifies the high-order SI data for each respective sample node, and generates an output SI embedding vector 683b representing additional SI data for each respective node. In some cases, the layer 682b generates the output vector 683b based on a portion of the vector 683a, such as a residual from the previous layer 682a. In some cases, the SI data and the output SI vector are further based on additional information from the sample nodes 430 or the feature graphs 425. For instance, the layer 682b determines the output SI vector 683b for each sample node based on one or more neighboring nodes of the sample node.

In FIG. 6, the output SI vector 683b is provided to a subsequent one of the layers 682. In some embodiments, each subsequent one of the layers 682 determines or modifies additional high-order SI data for each sample node, based on the output SI vector (e.g., a residual from the previous layer) and data representing neighboring nodes for each sample node (e.g., node relationships indicated by feature vectors 435). The final layer 682n generates an output SI embedding vector 683n representing SI data accumulated from some or all of the layers 682. In some cases, the output SI vector 683n represents the SI data for each sample node.

In some cases, the neural network 680 generates a combination or one or more of the output SI embedding vectors 683 from the layers 682. For example, the neural network 680 generates a concatenated layer output SI vector 685, based on a concatenation of the output SI vectors 683a, 683b, and each additional output SI vector including vector 683n. In some cases, the neural network 680 generates a respective concatenated layer output SI vector 685 for each node in the sample nodes 430. FIG. 5 depicts the combination of the output SI vectors 683 as a concatenation, but other combinations are possible, such as a sum, a product, a matrix having multiple rows or columns corresponding to output SI vectors, or any other suitable combination.

Based on the SI data generated by the layers 682, the graph convolutional neural network 680 generates the SI embedding vectors 675. In some cases, the vectors 675 include an SI embedding vector for one or more respective sample nodes. For example, the vectors 675 include the SI embedding vector 675a that is associated with the sample node 430a, based on a group of the output SI vectors 683 describing SI data for the sample node 430a. Additionally or alternatively, the vectors 675 includes the SI embedding vector 675b associated with the sample node 430b, based on output SI vectors 683 for the sample node 430b; the SI embedding vector 675n associated with the sample node 430n, based on output SI vectors 683 for the sample node 430n; and additional SI embedding vectors for additional sample nodes, based on respective groups of the output SI vectors 683 describing SI data for the respective sample nodes.

In some cases, one or more of the SI embedding vectors 675 are based on a combination of the output SI embedding vectors 683, such as the concatenated layer output SI vector 685. For example, each of the embedding vectors 675a, 675b, and 675n can be based on respective concatenated layer output SI vector that is associated with the respective sample node 430a, 430b, and 430n.

In some embodiments, a graph convolutional neural network included in an SI component is configured to determine one or more SI embedding vectors based on a graph convolutional operation performed on one or more high-order FI embedding vectors output from multiple layers of a high-order FI neural network. For example, the graph convolutional neural network 680 is configured to determine the SI embedding vector 675 based on graph convolution of one or more of the output FI embedding vectors 553 from the high-order FI neural network 550. Equations 7.1, 7.2, and 7.3 (collectively referred to herein as Equation 7) describe a non-limiting example of a graph convolutional model for determining an SI embedding vector based on a high-order FI embedding vector.

$$\begin{matrix}{\hat{h}}_{i}^{l} = {h}_{i}^{l} + \frac{1}{\sqrt{\vert 𝒩 ( i ) \vert}} {\sum }_{{i}^{′} ∈ 𝒩 ( i )} \frac{1}{\sqrt{\vert 𝒩 ( {i}^{′} ) \vert}} {h}_{i}^{l} , ∘ {h}_{i}^{l} & Eq . 7.1 \\ {h}_{i}^{l + 1} = σ ( {W}^{l + 1} {\hat{h}}_{i}^{l} ) & Eq . 7.2 \\ {h}_{i}^{0} = {\sum }_{p : {x}_{i , p} = 1} {v}_{p} & Eq . 7.3\end{matrix}$$

In Equation 7, an SI embedding vector ĥᵢ^{l} is determined for a sample node i, via a layer l. For example, the graph convolutional neural network 680 can include a model based on equation 7 to determine the output SI vectors 683. In some cases, the SI embedding vector ĥᵢ^{l} is a hidden vector, indicating a hidden state of a layer in a neural network (e.g., the neural network 680). The output SI embedding vector ĥᵢ^{l} can be determined based on a feature vector, such as a node-wise feature vector xᵢ described in regards to Equations 1 and 2. In some cases, the graph convolutional neural network 680 can include multiple layers 682 having respective models based on Equation 7. The multiple layers 682 can determine the output SI vectors 683, for example, by determining a respective output SI embedding vector ĥᵢ^{l} by each layer l in the layers 682.

In Equation 7.1, the SI embedding vector hᵢ^{l} is determined based on the neighbor group [symbol] (i) for the sample node i. Further in Equation 7.1, the SI embedding vector hᵢ^{l} is determined based on the additional neighbor group [symbol] (i′) for an additional sample node i′, where the additional sample node i′ is a neighbor of the sample node i. For example, the SI embedding vector ĥᵢ^{l} is based on an element-wise product of a high-order FI embedding vector hᵢ^{l} for the sample node i and an additional high-order FI embedding vector h_{i′}^{l} for the sample node i′, such as from the output high-order FI embedding vectors 553. In Equation 7.1, the SI embedding vector ĥᵢ^{l} is based on, for each neighbor node i′ of the sample node i, a square root operation performed on the value of the additional neighbor group [symbol] (i′) multiplied by the element-wise product of the high-order FI embedding vectors hᵢ^{l} and h_{i′}^{l}. In Equation 7.1, the products of the above-described multiplication operation for each neighbor node i′ are summed. Further in Equation 7.1, the summation is multiplied by an additional square root operation performed on the value of the neighbor group [symbol] (i) for the sample node i, and the product of this multiplication operation is added to the high-order FI embedding vector hᵢ^{l}. In some cases, a graph convolutional neural network that is configured to use a model based on Equation 7.1 can generate an SI embedding vector that more accurately represents sample interactions. For example, a layer l configured based on Equation 7.1 can provide an explicit sample interaction based on the element-wise product of the high-order FI embedding vectors hᵢ^{l} and h_{i′}^{l}.

In Equation 7.2, a layer l can determine a residual SI embedding vector hᵢ^{l+1} based on the SI embedding vector ĥᵢ^{l}. In Equation 7.2, the SI embedding vector ĥᵢ^{l} is multiplied by a weighting vector W^{l+1}, such as a weighting vector that includes one or more weighting factors that indicate modifications (e.g., modifications for a residual connection) to respective values in the SI embedding vector ĥᵢ^{l}. The weighting vector W^{l+1} may, but need not, have particular weighting factor values for each sample node i. In some cases, the sigmoid function a performs a non-linear transformation of the product of the weighting vector W^{l+1} and the SI embedding vector ĥᵢ^{l}. In some cases, the residual SI embedding vector hᵢ^{l+1} is provided to a subsequent layer l+1, such as to a subsequent layer in the layers 682. In some cases, a graph convolutional neural network that is configured to use a model based on Equation 7.2 can generate an SI embedding vector that more accurately represents sample interactions. For example, a layer l that receives a residual connection based on Equation 7.2 can determine sample interactions both linearly and exponentially.

In Equation 7.3, an initial layer (e.g., l=1) can determine an original high-order FI embedding vector hᵢ⁰ based on features p represented in a feature relation vector vₚ. In some cases, the feature relation vector vₚ is included in (or otherwise based on) the high-order FI embedding vector hᵢ^{l} received by the initial layer. In Equation 7.3, the original high-order FI embedding vector hᵢ⁰ is determined based on a sum of the feature relation vector vₚ over the features p. In some cases, the sum is summed over multiple features p: xᵢ where p=1. For example, the sum is based on the feature relation vector vₚ for features p included in the feature vector xᵢ, where the sum includes features p that have a value of 1 in the feature vector xᵢ and excludes features p that have values other than 1 (e.g., value of 0, undefined value). In some cases, the features p are binary features included in a node-wise feature vector xᵢ.

In some cases, a graph convolutional neural network configured to use a model based on Equation 7 can generate an SI embedding vector that represents sample interactions between or among sample nodes (e.g., the neighbors of sample node i) based on the high-order feature interactions (e.g., vectors hᵢ^{l} and h_{i′}^{l}) of the sample node and its neighbors. In some cases, a graph convolutional neural network configured to use a model based on Equation 7 can generate SI data that more accurately describes high-order feature interactions that are shared (or otherwise related) among two or more sample nodes.

In some embodiments, the SI component 670, or the DRFM system 410 in which the SI component 670 is included, can generate a high-order prediction 615. The high-order prediction 615 can be based on a combination of one or more of the SI embedding vectors 675 with one or more of the multi-node high-order FI embedding vectors 545. Additionally or alternatively, the high-order prediction 615 can include a respective high-order prediction for each of the sample nodes 430. For example, the SI component 670 or the DRFM system 410 could generate the high-order prediction 615 for the sample node 430a based on a combination of the multi-node high-order FI embedding vector 545a and the SI embedding vector 675a. In some cases, the high-order prediction 615 can be provided to one or more additional computing systems, such as the prediction system 190 described in regards to FIG. 1. Additionally or alternatively, the one or more additional computing systems are configured to perform one or more operations based on the high-order prediction 615, such as modifying a computing environment or providing at least a portion of the high-order prediction 615 via a user interface.

In some embodiments, a DRFM system, or an RFI component or an SI component included in the DRFM system, is configured to generate a high-order prediction based on one or more of an SI embedding vector or a multi-node high-order FI embedding vector. For example, the DRFM system 410 (or one or more of the included components 540 or 670) can be configured to generate the high-order prediction 615 based on the SI embedding vectors 675 and the multi-node high-order FI embedding vectors 545. Equation 8 describes a non-limiting example of a prediction model that can be used to generate a high-order prediction.

ŷ_{ι}=[(hᵢ^{RFI})^{T},(hᵢ^{SI})^{T}]W Eq. 8

In Equation 8, a high-order prediction ŷ_{ι} is determined for a sample node i. Equation 8 includes the multi-node FI embedding vectors hᵢ^{RFI} (as described in regards to Equation 6). In addition, Equation 8 includes a concatenated SI embedding vector hᵢ^{SI} that is based on a concatenation of the SI embedding vectors ĥᵢ^{l} (as described in regards to Equation 7) for each layer l. For example, the concatenated SI embedding vector hᵢ^{l} can be based on a concatenation of each of the output SI vectors 683. In Equation 8, a transposition of the multi-node FI embedding vector hᵢ^{RFI} is concatenated with an additional transposition of the concatenated SI embedding vector hᵢ^{SI}. Further in Equation 8, the concatenation of the vectors hᵢ^{RFI} and hᵢ^{SI} is multiplied by a weighting factor W. In some cases, the weighting factor W has a particular value for each sample node i. In some embodiments, a DRFM system provides part or all of the high-order prediction ŷ_{ι} to an additional computing system. For example, the DRFM system 410 could provide a particular high-order prediction A for a particular sample node i (e.g., i=1) to a prediction computing system.

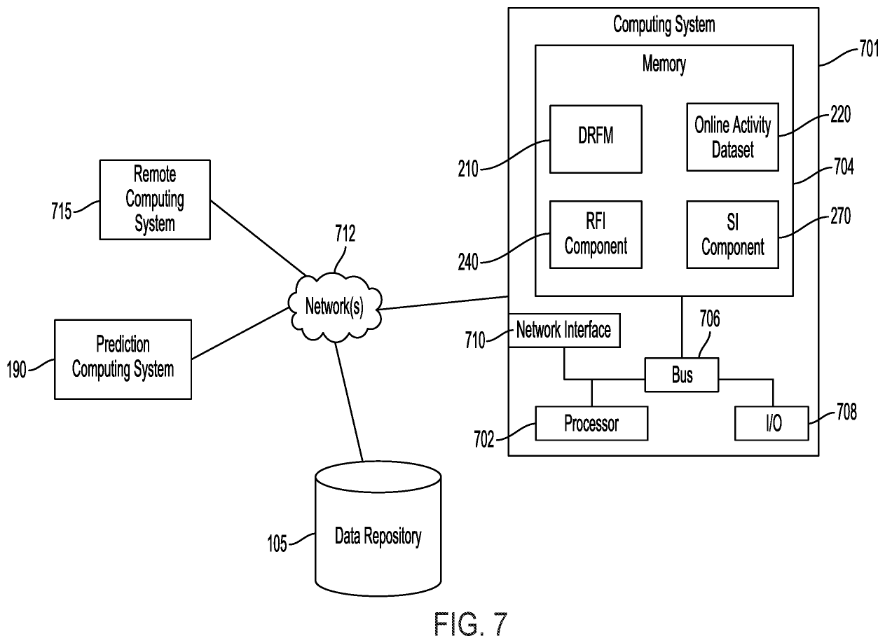

Any suitable computing system or group of computing systems can be used for performing the operations described herein. For example, FIG. 7 is a block diagram depicting a computing system 701 that is configured to provide a DRFM system (such as the DRFM system 110) according to certain embodiments.

The depicted example of a computing system 701 includes one or more processors 702 communicatively coupled to one or more memory devices 704. The processor 702 executes computer-executable program code or accesses information stored in the memory device 704. Examples of processor 702 include a microprocessor, an application-specific integrated circuit (“ASIC”), a field-programmable gate array (“FPGA”), or other suitable processing device. The processor 702 can include any number of processing devices, including one.

The memory device 704 includes any suitable non-transitory computer-readable medium for storing the DRFM 210, the online activity dataset 220, the RFI component 240, the SI component 270, and other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 701 may also include a number of external or internal devices such as input or output devices. For example, the computing system 701 is shown with an input/output (“I/O”) interface 708 that can receive input from input devices or provide output to output devices. A bus 706 can also be included in the computing system 701. The bus 706 can communicatively couple one or more components of the computing system 701.

The computing system 701 executes program code that configures the processor 702 to perform one or more of the operations described above with respect to FIGS. 1-6. The program code includes operations related to, for example, one or more of the DRFM 210, the online activity dataset 220, the RFI component 240, the SI component 270, or other suitable applications or memory structures that perform one or more operations described herein. The program code may be resident in the memory device 704 or any suitable computer-readable medium and may be executed by the processor 702 or any other suitable processor. In some embodiments, the program code described above, the DRFM 210, the online activity dataset 220, the RFI component 240, and the SI component 270 are stored in the memory device 704, as depicted in FIG. 7. In additional or alternative embodiments, one or more of the DRFM 210, the online activity dataset 220, the RFI component 240, the SI component 270, and the program code described above are stored in one or more memory devices accessible via a data network, such as a memory device accessible via a cloud service.

The computing system 701 depicted in FIG. 7 also includes at least one network interface 710. The network interface 710 includes any device or group of devices suitable for establishing a wired or wireless data connection to one or more data networks 712. Non-limiting examples of the network interface 710 include an Ethernet network adapter, a modem, and/or the like. A remote computing system 715 is connected to the computing system 701 via network 712, and remote computing system 715 can perform some of the operations described herein, such as storing sample nodes or a high-order prediction. The computing system 701 is able to communicate with one or more of the remote computing system 715, the prediction computing system 190, and the data repository 105 using the network interface 710. Although FIG. 7 depicts the data repository 105 as connected to computing system 701 via the networks 712, other embodiments are possible, such as at least a portion of the data repository 105 residing as a data structure in the memory 704 of computing system 701.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method comprising:
accessing, with a processing device executing a deep relational factorization machine (“DRFM”), digital activity data;
determining, by a relational feature interaction component of the DRFM, a first feature interaction embedding vector that describes high-order interactions among at least three features included in a first subset of the digital activity data and a second feature interaction embedding vector that describes high-order interactions among at least three features included in a second subset of the digital activity data;
generating, by a sample interaction component of the DRFM, a sample interaction embedding vector that describes sample interactions between the first subset and the second subset, wherein the sample interaction embedding vector is generated based on a combination of the first feature interaction embedding vector and the second feature interaction embedding vector;
generating, by the DRFM and based on a combination of the sample interaction embedding vector, the first feature interaction embedding vector, and the second feature interaction embedding vector, a high-order prediction that comprises a probability of additional digital activity; and
providing the high-order prediction to a prediction computing system.

2. The method of claim 1, further comprising:
generating, by the relational feature interaction component of the DRFM, a first feature graph indicating co-occurrences of features included in the first subset of digital activity data, wherein the first feature interaction embedding vector is determined based on the co-occurrences indicated by the first feature graph;
generating, by the relational feature interaction component of the DRFM, a second feature graph indicating additional co-occurrences of additional features included in the second subset of digital activity data, wherein the second feature interaction embedding vector is determined based on the additional co-occurrences indicated by the second feature graph.

3. The method of claim 1, wherein each of the first subset of the digital activity data and the second subset of the digital activity data corresponds to a respective computing device or a respective online campaign.

4. The method of claim 1, wherein each feature included in the digital activity data is a binary feature describing a characteristic of the digital activity data.

5. The method of claim 1, wherein each of the first feature interaction embedding vector and the second feature interaction embedding vector is determined via a modified graph convolutional operation.

6. The method of claim 5, further comprising:
calculating the first feature interaction embedding vector based on the modified graph convolutional operation of a first subset of feature graph entries, and
calculating the second feature interaction embedding vector based on the modified graph convolutional operation of a second subset of feature graph entries.

7. The method of claim 1, further comprising:
concatenating the first feature interaction embedding vector with the second feature interaction embedding vector,
wherein determining the sample interaction embedding vector is further based on the concatenated feature interaction embedding vectors.

8. The method of claim 1, further comprising:
concatenating the sample interaction embedding vector with an additional sample interaction embedding vector,
wherein determining the high-order prediction is further based on the concatenated sample interaction embedding vectors.

9. A non-transitory computer-readable medium having program code stored thereon, the program code executable by a processor to perform operations comprising:
accessing digital activity data having binary features;
generating a feature graph representing co-occurrences among the binary features in the digital activity data;
a step for computing a high-order prediction indicating a probability of an additional digital activity based on the feature graph; and
providing the high-order prediction to a prediction computing system.

10. The non-transitory computer-readable medium of claim 9, wherein the digital activity data includes a sparse dataset having high cardinality.

11. The non-transitory computer-readable medium of claim 9, the operations further comprising:
a step for determining a high-order feature interaction embedding vector that describes high-order feature interactions among at least three of the binary features represented by the feature graph,
wherein computing the high-order prediction is further based on the high-order feature interaction embedding vector.

12. The non-transitory computer-readable medium of claim 11, the operations further comprising:
a step for concatenating the high-order feature interaction embedding vector with an additional high-order feature interaction embedding vector that describes additional high-order feature interactions among at least three additional binary features of the digital activity data.
wherein computing the high-order prediction is further based on the concatenated high-order feature interaction embedding vectors.

13. The non-transitory computer-readable medium of claim 9, the operations further comprising:
a step for generating a sample interaction embedding vector that describes sample interactions among subsets of the digital activity data, wherein the sample interaction embedding vector is based on a combination of:
high-order feature interactions among binary features represented by the feature graph, and
additional high-order feature interactions among additional binary features represented by an additional feature graph.

14. The non-transitory computer-readable medium of claim 13, the operations further comprising concatenating the sample interaction embedding vector with an additional sample interaction embedding vector,
wherein determining the high-order prediction is further based on the concatenated sample interaction embedding vectors.

15. A system comprising:
a deep relational factorization machine comprising:
a relational feature interaction component for generating a first feature interaction embedding vector and a second feature interaction vector that describe feature interactions between features of digital activity data;
a graph convolutional neural network (“GCN”) for generating a convolutional combination of the first feature interaction embedding vector and the second feature interaction embedding vector, wherein the convolutional combination describes sample interactions between subsets of the digital activity data; and
an output component configured for generating, from the feature interaction embedding vector and the sample interaction embedding vector, a high-order prediction indicating a probability of an additional digital activity.

16. The system of claim 15, wherein each of the first feature interaction embedding vector and the second feature interaction embedding vector is determined via a modified graph convolutional operation.

17. The system of claim 15, the relational feature interaction component further configured for:
calculating the first feature interaction embedding vector based on the modified graph convolutional operation of a first subset of feature graph entries, and
calculating the second feature interaction embedding vector based on the modified graph convolutional operation of a second subset of feature graph entries.

18. The system of claim 15, the relational feature interaction component further configured for:
generating a first feature graph indicating co-occurrences of features included in a first subset of the digital activity data, wherein the first feature interaction embedding vector is generated based on co-occurrences indicated by the first feature graph; and
generating a second feature graph indicating additional co-occurrences of additional features included in a second subset of the digital activity data, wherein the second feature interaction embedding vector is generated based on the additional co-occurrences indicated by the second feature graph.

19. The system of claim 15, the GCN further configured for:
generating a sample interaction embedding vector based on the convolutional combination of the first feature interaction embedding vector and the second feature interaction embedding vector; and
generating an additional sample interaction embedding vector describing additional sample interactions between additional subsets of the digital activity data.

20. The system of claim 19, the GCN further configured for:
concatenating the sample interaction embedding vector with additional sample interaction embedding vector,
wherein generating the high-order prediction is further based on the concatenated additional sample interaction embedding vectors.
